(19) United States
(12) Patent Application Publication
(10) Pub. No.: US 2019/0104198 A1
(43) Pub. Date: Apr. 4, 2019

(54) ACCELERATED THROTTLING FOR WEB SERVERS AND SERVICES

(71) Applicant: MICROSOFT TECHNOLOGY LICENSING, LLC, Redmond, WA (US)

(72) Inventors: Akshay N. MUTHA, Sammamish, WA (US); Shanna X. CHEN, Seattle, WA (US); Rohit D. MAHALE, Issaquah, WA (US)

(73) Assignee: MICROSOFT TECHNOLOGY LICENSING, LLC, Redmond, WA (US)

(21) Appl. No.: 15/724,427

(22) Filed: Oct. 4, 2017

(51) Int. Cl. H04L 29/08; H04L 12/911; H04L 12/24; H04L 12/873

(52) U.S. Cl. CPC H04L 67/322; H04L 47/70; H04L 47/781; H04L 43/0876; H04L 47/52; H04L 67/16; H04L 41/0896; H04L 41/5054

(57) ABSTRACT

Accelerated throttling for web servers and services is provided. Request data may be collected for requests submitted to servers at a datacenter and a request metric and a window determined based on the collected information. The request metric may define a limit for a number of requests from a source to be accepted within the window. Incoming requests for the servers at the datacenter may be monitored and, in some cases, sources for the requests identified. If a number of requests from a source exceed the determined request metric within the window, further requests from the same source may be denied until the window expires. The incoming requests for the servers at the datacenter may be monitored by counting a subset of the incoming requests associated with the identified source, for example.

### BACKGROUND

In the information technology age, datacenters provide environments for a wide variety of hosted services. Ranging from collaboration services to highly specialized computation services, hosted services are typically executed on a number of servers and accessed by “clients”, which may be users, applications executed on user computing devices, platforms, and more. At a basic level, a hosted service receives a request, the request is directed to a particular server, the server performs an action associated with the request, and returns a result. This basic process is repeated very large number of times by each server at a datacenter.

Despite variations related to provided services, user/platform types, etc., a typical source may provide a forecastable number of requests in a given time period, which allows datacenter operators to determine and adjust number of servers, workloads, etc. In some cases, such as malicious attacks or programming errors in client applications, a source may submit an extraordinary number of requests consuming valuable datacenter resources and possibly causing degradation of service. Conventional measures against sudden increase of requests tend to err on the conservative side inconveniencing legitimate requestors or on the liberal side resulting in loss of service by the time the issue is caught and addressed.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to accelerated throttling for web servers and services. A management service or application at a datacenter may collect request data for requests submitted to servers at the datacenter such as number of requests from different sources, timing of requests, types of requests, etc. A request metric and window defining how many requests within the window are to be allowed for the request sources may be determined based on the collected information. The management service or application may monitor incoming requests and optionally identify sources of the requests. If a number of requests from a source within a particular window exceed the determined request metric, further requests may be denied until the window expires. The monitoring and counting may begin again when a subsequent window begins.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a display diagram illustrating an example network environment where a system to provide accelerated throttling for web servers and services may be implemented;

FIG. 2 includes a display diagram illustrating an example flow of requests to a datacenter, which may be forwarded to appropriate servers or rejected based on a request metric based decision;

FIG. 3 includes a display diagram illustrating an example management module or application performing actions associated with accelerated throttling for web servers and services and controlling flow of requests to servers of a datacenter;

FIG. 4 includes a display diagram illustrating an example datacenter environment, where common cache based request monitoring and throttling may be performed for groups of servers;

FIG. 5 is a networked environment, where a system according to embodiments may be implemented;

FIG. 6 is a block diagram of an example computing device, which may be used to provide accelerated throttling for web servers and services; and

FIG. 7 illustrates a logic flow diagram of a method to provide accelerated throttling for web servers and services,

all arranged in accordance with at least some embodiments described herein.

### DETAILED DESCRIPTION

As briefly described above, embodiments are directed to accelerated throttling for web servers and services. In some examples, request data may be collected for requests submitted to servers at a datacenter and a request metric and a window determined based on the collected information. The request metric may define a limit for a number of requests from a source to be accepted within the window. Incoming requests for the servers at the datacenter may be monitored and, in some cases, sources for the requests identified. If a number of requests from a source exceed the determined request metric within the window, further requests from the same source may be denied until the window expires. The incoming requests for the servers at the datacenter may be monitored by counting a subset of the incoming requests associated with the identified source, for example. A counted number of requests from the source may be reset upon expiration of the window and the counting of the requests associated with the identified source may be restarted upon start of a new window.

The request metric may be static or dynamic and may be determined based on historic usage information. For example, an average number of requests from a source (or multiple sources) may be computed over a predefined period and summed with a buffer number of requests to avoid false positives. In some cases, the metric may be weighted based on factors such as a timing of the requests, a type of the requests, a type of different sources, and/or a type of servers receiving the requests. The management module or application may collect request data for requests submitted to the servers while monitoring the incoming requests and dynamically update the metric and/or the window.

Example embodiments are described herein for accelerated throttling for web servers and services. Embodiments are not limited to application of the discussed metrics and utilization to the example datacenter configurations, however, and may be implemented in any entity comprising a number of servers or similar computing devices using the principles described herein.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing accelerated throttling for web servers and services. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

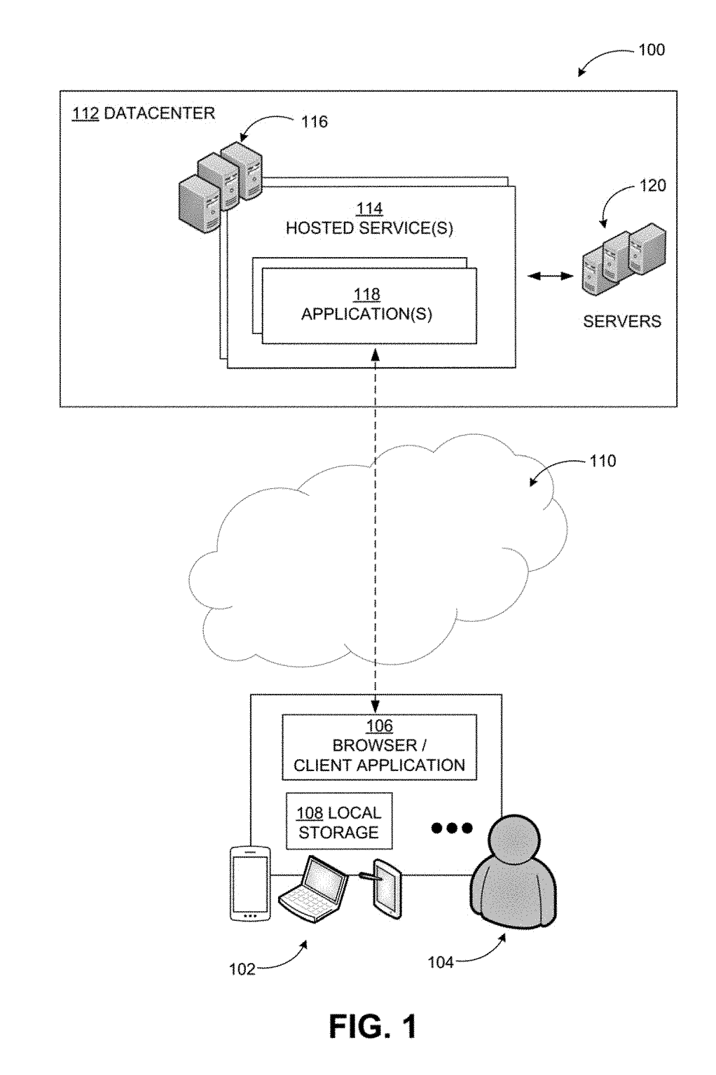

FIG. 1 includes a display diagram illustrating an example network environment where a system to provide accelerated throttling for web servers and services may be implemented.

As illustrated in diagram 100, an example system may include a datacenter 112 executing a hosted service 114 on at least one processing server 116, which may provide productivity, communication, cloud storage, collaboration, and comparable services to users in conjunction with other servers 120, for example. The hosted service 114 may further include scheduling services, online conferencing services, and comparable ones. The hosted service 114 may be configured to interoperate with a client application 106 through one or more client devices 102 over one or more networks, such as network 110. The client devices 102 may include a desktop computer, a laptop computer, a tablet computer, a vehicle-mount computer, a smart phone, or a wearable computing device, among other similar devices. In some examples, the hosted service 114 may allow users to access its services through the client application 106 executed on the client devices 102. In other examples, the hosted service 114 may be provided to a tenant (e.g., a business, an organization, or similar entities), which may configure and manage the services for their users.

In an example embodiment, as illustrated in diagram 100, the servers 116 may be operable to execute programs associated with the hosted service 114 and/or applications 118. At basic level, a client (e.g., user 104 through browser or client application 106 or another service/application) may submit a request to the servers 116. Servers 116 may execute actions associated with the request (e.g., retrieve data from storage, perform computation, etc.), and reply with the result. In a typical operating environment, very large number of requests, executions, and replies may flow through the datacenter 112 at any given time. Datacenter 112 may expect to receive a forecastable number of requests over any period of time and, thus, configure its servers and other infrastructure components accordingly. However, in some cases like malicious attacks (e.g., denial of service attacks) or if the requesting application/service has a programmatic error, an abnormally high number of requests may be received straining the resources of the datacenter, possibly causing shutdown of multiple servers. A system according embodiments may allow rapid decision making on throttling a request source without making calls to a datacenter-wide cache, which is typically network based, thereby, saving network bandwidth and even further reducing load on the servers. A management service/application/module executed on each of the request processing servers may accomplish this by implementing a request metric and a window and denying requests to sources whose request metric exceeds a predetermined limit within a given window. Requests from the same source sent to different servers may still be counted toward the limit (within the window) by implementing a request counter on a common cache for a group of servers. Furthermore, processing and network capacity may be preserved, data security may be enhanced, usability may be improved, and user interactivity may be increased through accelerated throttling for web servers and services.

Embodiments, as described herein, address a need that arises from a very large scale of operations created by software-based services that cannot be managed by humans. The actions/operations described herein are not a mere use of a computer, but address results of a system that is a direct consequence of software used as a service offered in conjunction with a large number of devices and users using hosted services.

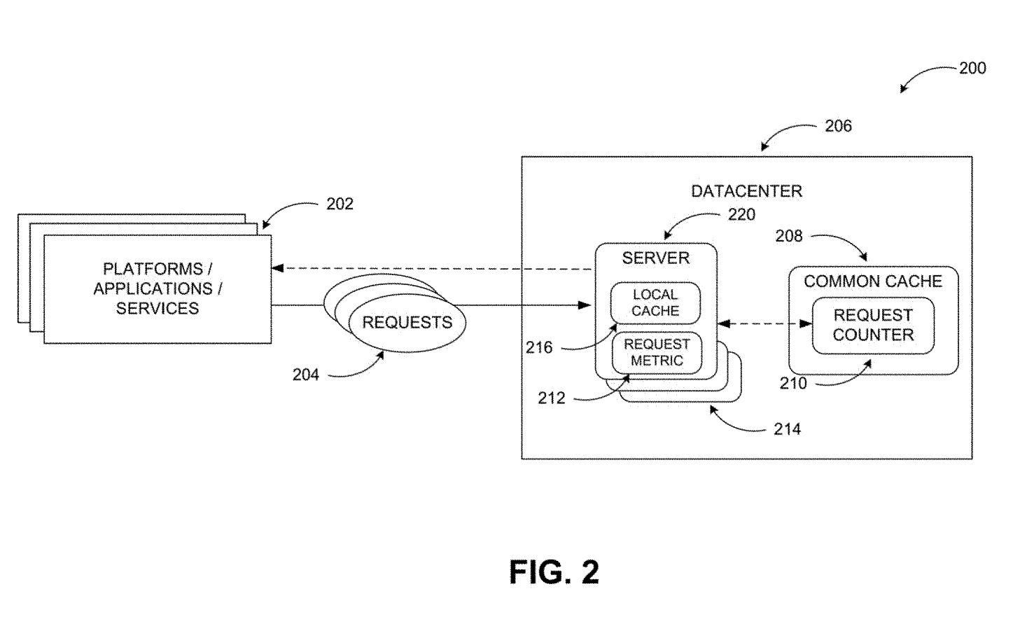

FIG. 2 includes a display diagram illustrating an example flow of requests to a datacenter, which may be forwarded to appropriate servers or rejected based on a request metric based decision.

As shown in diagram 200, datacenter 206 may include a number of servers. Groups of servers 214 may share a common cache 208. In some examples, platforms/applications/services 202 may submit a request 204 to the datacenter 206. Server 220 among the group of servers 214 may receive the request 204. The server 220 may extract needed information from the request such as source of the request, device identifier, user details, type of operating system, type of application, etc. Any one of the extracted information, combinations thereof, or additional information (e.g., requests from a specific user coming from a specific operating system for a specific application) may be used to determine the request metric 212 (e.g., at the management module or application executed on the receiving server). Next, a current time window value may be computed. The request metric 212 computations may be performed at the server 220. The module may create a bucket/key value based on specific combinations of information received from the request and the current time window value. The window may be a moving window, that is a predefined period of time that is successively repeated (e.g., current 30 minute time slot, next 30 minute time slot, etc.). To create the buckets, the guidelines, rules, and formulas may be stored at the server 220 itself. Thus, no network calls may be needed during the process. The server may look up the bucket/key value in local cache 216 at the server 220. If there is an entry, then the server 220 may block the request 204 and return a “throttled” response or an error to the caller (source of the request).

If there is no entry in local cache 216, then the server 220 may check the common cache 208 shared with other servers at the datacenter 206 to determine if there is an entry for the particular bucket/key present. The entry in common cache 208 is the counter 210 of the request.

If the entry is present at the common cache 208, the server 220 may read the numeric value and try to make a decision whether the request metric threshold is met or not by analyzing the limit data present at the server 220 itself or heuristic data present at a separate database/flash-memory, etc. If the threshold is met, then a record may be written into local cache 216 at the server 220 and a “throttled” response or an error response may be returned to the caller. If the threshold is not met, then the value in the bucket may be incremented and request may be allowed to go through the system (answered by the server). If bucket/key does not exist in the common cache 208, then the record (request counter 210) may be created and the value set to a default (e.g., 1). This is the start of the request counter 210.

Use of request metric according to embodiments may be implemented for anonymous requests, unidentified requests, or identified requests. Identification of the requestor (source) may include authentication. The identification/authentication may be used to determine scenarios for expected request levels. To determine the request metric, information such as a number of requests from different sources, a timing of the requests, a type of the requests, and/or a type of the different sources may be collected. The request metric may be determined for all sources/requests or for individual (or groups of) sources. For example, the metric may be determined based on a type of the source (e.g., an application, a hosted service, a user, a platform, or a version of an application, a hosted service, or a platform).

In yet other examples, the window may also be determined statically or dynamically. A single window (time period) may be used to apply the request metric for all requests, sources, and datacenter resources (servers). On the other hand, the window may be customized for select groups of sources or request types. Thus, resource preservation may be achieved through selection of number of requests to be accepted or time period over which the number of requests are counted.

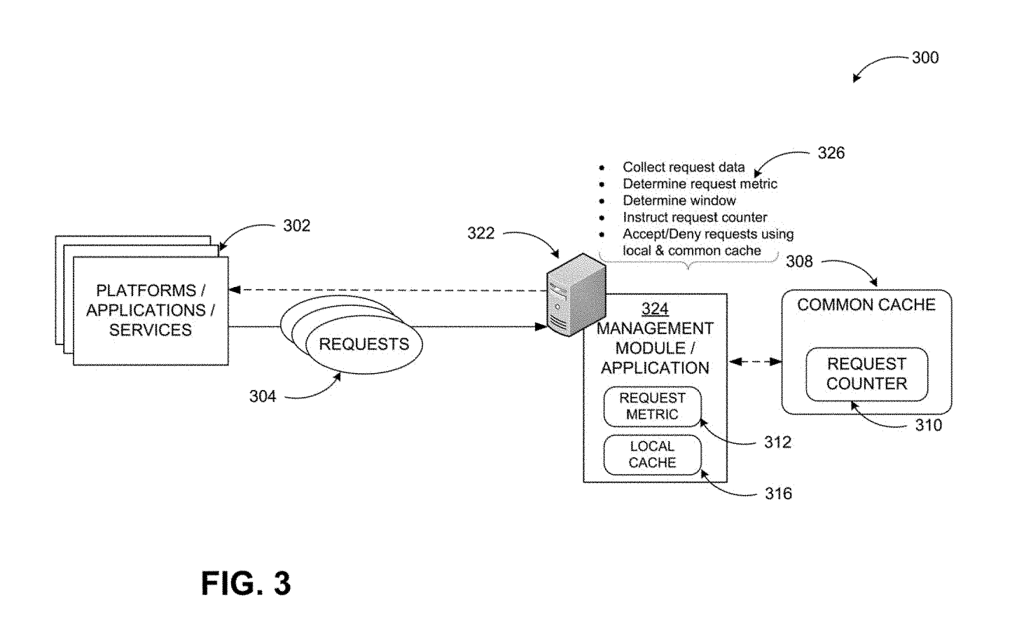

FIG. 3 includes a display diagram illustrating an example management module or application performing actions associated with accelerated throttling for web servers and services and controlling flow of requests to servers of a datacenter.

Diagram 300 shows how incoming requests 304 from platforms, application, or services 302 for a server 322 at a datacenter may be monitored by counting a subset of the incoming requests associated with an identified source in a bucket, for example, by a management module or application 324 executed at the server 322. A counted number of requests from the same source may be reset upon expiration of the window and the counting of the requests associated with the identified source may be restarted upon start of a new window.

In some examples, a record may be created or updated at a common cache 308 of the datacenter for every incoming request. The record may include a counter 310 for the request, a source identifier, and a window identifier. The record may be stored at the common cache 308 as a combination key of the counter 310 for the request, the source identifier, and the window identifier (bucket). The management module or application 324 may look up the bucket/key value in local cache 316 at the server 322. If there is an entry, then the server may block the request and return a “throttled” response or an error to the caller (source of the request). If there is no entry in local cache 316, then the management module or application 324 may check the common cache 308 shared with other servers at the datacenter to determine if there is an entry for the particular bucket/key present. The entry in common cache 308 is the request counter 310. If the entry is present at the common cache 308, the management module or application 324 may read the numeric value and try to make a decision whether the request metric threshold is met or not by analyzing the limit data present at the server 322 itself or heuristic data present at a separate database/flash-memory, etc. If the threshold is met, then a record may be written into local cache 316 at the server 322 and a “throttled” response or an error response may be returned to the caller. If the threshold is not met, then the value in the bucket may be incremented and request may be allowed to go through the system (answered by the server 322). The common cache 308 may be associated with all or a subset of the servers at the datacenter such that all requests submitted to the servers can be monitored through the common cache 308.

The request metric 312 may be static or dynamic and may be determined based on historic usage information. For example, an average number of requests from a source (or multiple sources) may be computed over a predefined period and summed with a buffer number of requests to avoid false positives. In some cases, the metric may be weighted based on factors such as a timing of the requests, a type of the requests, a type of different sources, and/or a type of servers receiving the requests. As part of its tasks 326, the management module or application 324 may collect request data for requests submitted to the server 322 while monitoring the incoming requests and dynamically update the metric and/or the window.

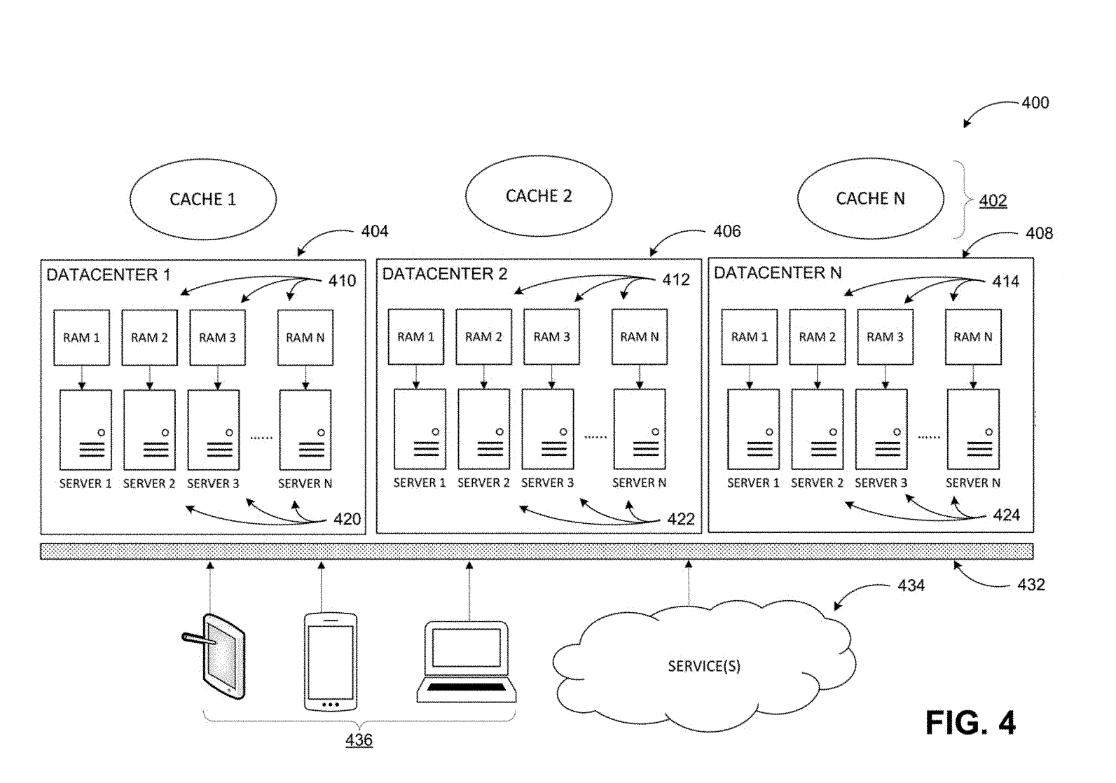

FIG. 4 includes a display diagram illustrating an example datacenter environment, where common cache based request monitoring and throttling may be performed for groups of servers.

Diagram 400 shows an example server farm configuration. The server farm may host a number of datacenters 404, 406, 408. Each datacenter may include a number of servers 420, 422, 424 and associated memories (RAMs 410, 412, 414). The servers of each datacenter may also be associated with a common cache 402 for the respective datacenters. Requests may be submitted by various endpoints (applications, service, platforms, and different versions of each) or users (through an application) to the datacenters. For example, applications executed on different operating systems at various computing devices 436 may submit requests, as well as, hosted services 434 on the cloud. Request calls may go through special purpose hardware and/or software 432 such as firewalls, etc.

In some examples, a request metric to throttle the requests for each endpoint or network source (e.g., URL) may be defined (e.g., requests higher than 50 over any 30-minute period). For every request a source making the call may be identified and a record may be created/updated in the common cache that identifies if the maximum number of allowed requests is reached. A source identifier may indicate the source and a window identifier may indicate the current time in the record. The record in the common cache may store the number of hits for each source-window combination as a key. The management module or application of each server may then query the common cache to determine if the maximum allowed hits is reached. If the metric is exceeded, further request still within the window may be denied, for example, with an error message. Once the window is expired, a new window (and a new combination key) may be generated and counting reset.

Common cache may be any form of shared memory. If a source is a new source, a default metric may be used and the metric subsequently updated as usage information about the new source is collected and analyzed. By using the common cache as the location for counting, throttling decision may be shared at datacenter level. Thus, any machine receiving requests in that datacenter may be able to reject requests as soon as datacenter level throttling limits are exceeded.

By keeping the windows static and restarting them after a previous one has expired, sources may be allowed to submit a reasonable number of requests without experiencing a degradation of service. A duration of the window and conditions based on which the requests are to be throttled may be configurable and stay on every server. Thus, a separate server does not need to be reached to obtain configuration values. Reaching a different server for configuration typically involves network access, which is a network resource that may be degraded during a malicious attack, for example.

The examples provided in FIGS. 1 through 4 are illustrated with specific systems, services, applications, modules, and configurations. Embodiments are not limited to environments according to these examples. Accelerated throttling for web servers and services may be implemented in environments employing fewer or additional systems, services, applications, modules, and displays. Furthermore, the example systems, services, applications, modules, and configurations shown in FIG. 1 through 4 may be implemented in a similar manner with other systems or action flow sequences using the principles described herein.

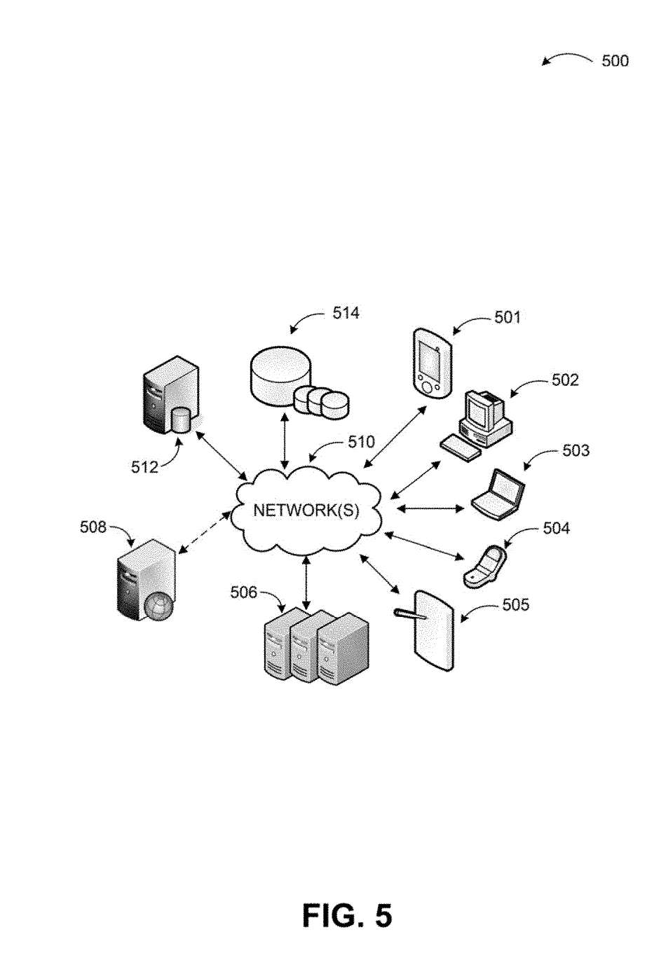

FIG. 5 is a networked environment, where a system according to embodiments may be implemented.

A management service (or module) as described herein may be employed in conjunction with hosted applications and services (for example, hosted service 114) that may be implemented via software executed over one or more servers 506 or individual server 508, as illustrated in diagram 500. A hosted service or application may communicate with client applications on individual computing devices such as a handheld computer 501, a desktop computer 502, a laptop computer 503, a smart phone 504, a tablet computer (or slate), 505 (‘client devices’) through network(s) 510 and control a user interface, such as a dashboard, presented to users.

Client devices 501-505 are used to access the functionality provided by the hosted service or client application. One or more of the servers 506 or server 508 may be used to provide a variety of services as discussed above. Relevant data may be stored in one or more data stores (e.g. data store 514), which may be managed by any one of the servers 506 or by database server 512.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, engines, data sources, and data distribution systems may be employed to provide accelerated throttling for web servers and services. Furthermore, the networked environments discussed in FIG. 5 are for illustration purposes only. Embodiments are not limited to the example applications, engines, or processes.

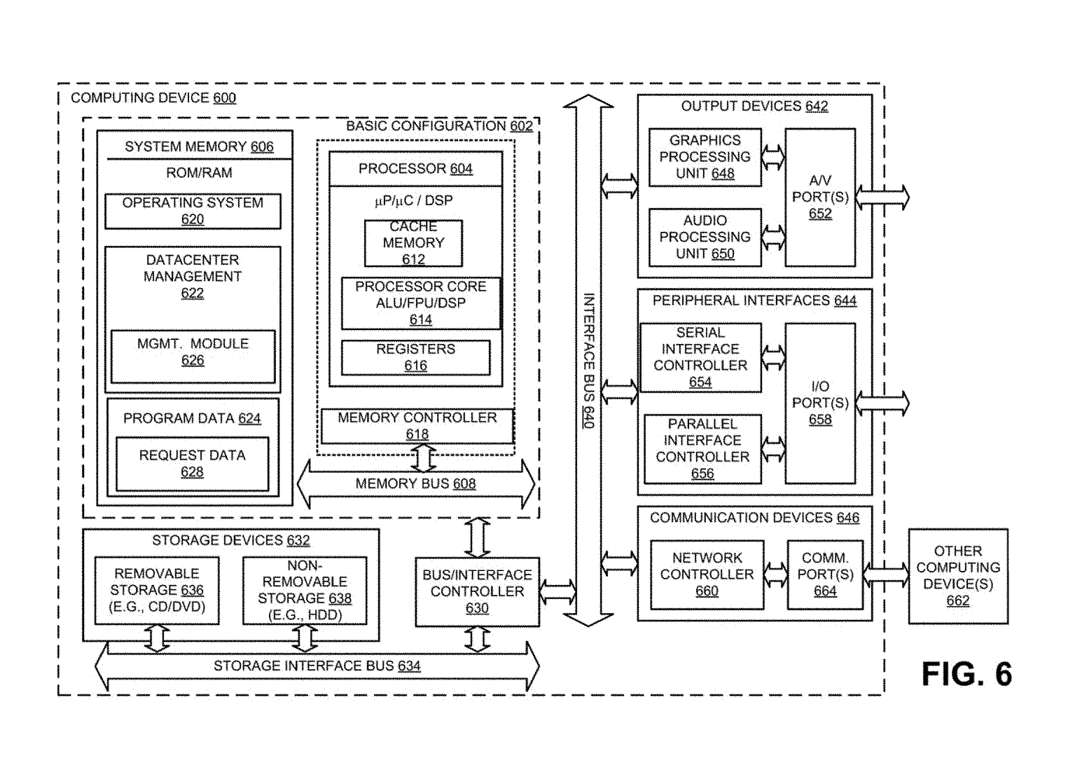

FIG. 6 is a block diagram of an example computing device, which may be used to provide accelerated throttling for web servers and services.

For example, computing device 600 may be used as a server, desktop computer, portable computer, smart phone, special purpose computer, or similar device for executing a management application or module for a datacenter. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (PP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a datacenter management application or service 622, and program data 624. The datacenter management application or service 622 may include a management module 626, which may be an integrated module of the datacenter management application or service 622. The management module 626 may be configured to collect request data for requests submitted to a server at the datacenter (computing device 600) such as number of requests from different sources, timing of requests, types of requests, etc. A request metric and window defining how many requests within the window to be allowed for the request sources may be determined based on the collected information. The management module 622 may monitor incoming requests and optionally identify sources of the requests. If a number of requests from a source within a particular window exceed the determined request metric, further requests may be denied until the window expires. The monitoring and counting may begin again when a subsequent window begins. The program data 624 may include, among other data, request data 628, such as number of requests received from particular sources over a defined period, etc., as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include methods to provide accelerated throttling for web servers and services. These methods can be implemented in any number of ways, including the structures described herein, One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

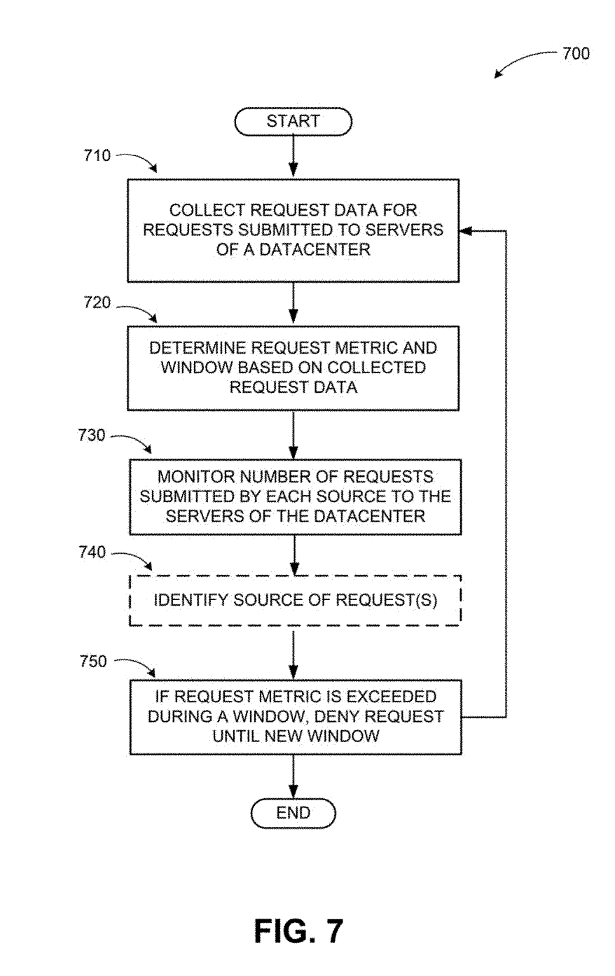

FIG. 7 illustrates a logic flow diagram of a method to provide accelerated throttling for web servers and services. Process 700 may be implemented on a computing device, server, or other system. An example server may comprise a communication interface to facilitate communication between one or more client devices and the server. The example server may also comprise a memory to store instructions, and one or more processors coupled to the memory. The processors, in conjunction with the instructions stored on the memory, may be configured to provide accelerated throttling for web servers and services.

Process 700 begins with operation 710, where request data for requests submitted to servers at the datacenter may be collected. Collected data may include a number of requests from different sources, a timing of the requests, a type of the requests, and/or a type of the different sources. At operation 720, a request metric and a window may be determined based on the collected information. The request metric may define a limit for a number of requests from a source to be accepted within the window.

At operation 730, incoming requests for a server at the datacenter may be monitored. For example, a record may be created and/or updated at a common cache of the servers for every incoming request. The record may include a counter for the request, a source identifier, and/or a window identifier. At optional operation 740, sources for the request may be identified. In some examples, the sources may be authenticated by the system. At operation 750, requests may be denied within the window if the metric is determined to be exceeded. For example, the requests associated with the identified source may be counted and in response to determining that a number of requests from the source exceed the determined request metric within the window, further requests from the source denied until the window expires.

The operations included in process 700 are for illustration purposes. Accelerated throttling for web servers and services may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing accelerated throttling for web servers and services is described. The means may include a means for collecting request data for requests submitted to servers at a datacenter; a means for determining a request metric and a window based on the collected request data, where the request metric defines a limit for a number of requests from a source to be accepted within the window; a means for monitoring incoming requests for a server at the datacenter; and in response to determining that a number of requests from the source exceed the determined request metric within the window, a means for denying further requests from the source until the window expires.

According to some examples, a method to provide accelerated throttling for web servers and services is described. The method may include collecting request data for requests submitted to servers at a datacenter, determining a request metric and a window based on the collected request data, where the request metric defines a limit for a number of requests from a source to be accepted within the window; monitoring incoming requests for a server at the datacenter; and in response to determining that a number of requests from the source exceed the determined request metric within the window, denying further requests from the source until the window expires.

According to other examples, the method may also include identifying the source. Monitoring the incoming requests for the server at the datacenter may include counting a subset of the incoming requests associated with the identified source. The method may further include resetting a counted number of requests from the source upon expiration of the window; and restarting the counting of the subset of the incoming requests associated with the identified source upon start of a new window. Identifying the source may include authenticating the source.

According to further examples, collecting the request data may include collecting one or more of a number of requests from different sources, a timing of the requests, a type of the requests, and a type of the different sources. The method may also include determining the resource metric for all requests or determining different resource metrics for different sources. Determining the different resource metrics for the different sources may include determining the different resource metrics based on types of the different sources. The method may further include determining different resource metrics for different endpoints associated with the datacenter. The endpoints may include one or more of an application, a hosted service, a user, a platform, or a version of an application, a hosted service, or a platform.

According to other examples, a server to provide accelerated throttling for web servers and services is described. The server may include a communication interface configured to facilitate communication between the server, and one or more computing devices; a memory configured to store instructions; and one or more processors coupled to the communication interface and the memory and configured to execute a management application for the server. The one or more processors may be configured to collect request data for requests submitted to the server at the datacenter; determine a request metric and a window based on the collected request data, where the request metric defines a limit for a number of requests from a source to be accepted within the window; monitor incoming requests for the server at the datacenter, identify a subset of requests from the source; count the subset of the requests associated with the identified source; and in response to determining that a number of requests from the source exceed the determined request metric within the window, deny further requests from the source until the window expires.

According to some examples, the one or more processors may be further configured to, for every incoming request, create or update a record at a local cache of the server and a common cache of the datacenter, the record comprising a counter for the request, a source identifier, and a window identifier. The record may be stored at the common cache as a combination key of the counter for the request, the source identifier, and the window identifier. The one or more processors may also be configured to, for every incoming request, query the common cache for a maximum value hit of the record to determine if the further requests are to be denied. The common cache may be associated with at least a subset of servers at the datacenter such that all requests submitted to the servers at the datacenter are monitored at the common cache.

According to further examples, a datacenter to provide accelerated throttling for web servers and services is described. The datacenter may include a common cache shared among a plurality of servers of the datacenter and the plurality of servers configured to execute one or more hosted services or applications. Each of the plurality of servers may include a communication interface configured to facilitate communication between the plurality of servers, and one or more computing devices submitting requests to the plurality of servers; a memory configured to store instructions; and one or more processors coupled to the communication interface and the memory and configured to execute a management application for a respective server. The one or more processors may be configured to determine a request metric and a window based on historic usage information, where the request metric defines a limit for a number of requests from a source to be accepted within the window; monitor incoming requests by creating or updating a record at a local cache of the respective server and at a common cache of the plurality of servers for every incoming request, the record comprising a counter for the request, a source identifier, and a window identifier; query the common cache for a maximum value hit of the record; and in response to determining the maximum value hit, deny further requests from the source until the window expires.

According to yet other examples, the metric may be determined based on a sum of an average number of requests from the source over a predefined period and a buffer number of requests. The metric may be weighted based on one or more of a timing of the requests, a type of the requests, a type of different sources, and a type of servers receiving the requests. The one or more processors may be further configured to collect request data for requests submitted to the respective server while monitoring the incoming requests; and dynamically update one or more of the metric and the window.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide accelerated throttling for web servers and services, the method comprising:
collecting request data for requests submitted to servers at a datacenter;
determining a request metric and a window based on the collected request data, wherein the request metric defines a limit for a number of requests from a source to be accepted within the window;
monitoring incoming requests for a server at the datacenter, and
in response to determining that a number of requests from the source exceed the determined request metric within the window, denying further requests from the source until the window expires.

2. The method of claim 1, further comprising:
identifying the source.

3. The method of claim 2, wherein monitoring the incoming requests for the server at the datacenter comprises:
counting a subset of the incoming requests associated with the identified source.

4. The method of claim 3, further comprising:
resetting a counted number of requests from the source upon expiration of the window; and
restarting the counting of the subset of the incoming requests associated with the identified source upon start of a new window.

5. The method of claim 2, wherein identifying the source comprises:
authenticating the source.

6. The method of claim 1, wherein collecting the request data comprises:
collecting one or more of a number of requests from different sources, a timing of the requests, a type of the requests, and a type of the different sources.

7. The method of claim 6, further comprising:
determining the resource metric for all requests.

8. The method of claim 6, further comprising:
determining different resource metrics for different sources.

9. The method of claim 8, wherein determining the different resource metrics for the different sources comprises:
determining the different resource metrics based on types of the different sources.

10. The method of claim 6, further comprising:
determining different resource metrics for different endpoints associated with the datacenter.

11. The method of claim 10, wherein the endpoints comprise one or more of an application, a hosted service, a user, a platform, or a version of an application, a hosted service, or a platform.

12. A server to provide accelerated throttling for web servers and services, the server comprising:
a communication interface configured to facilitate communication between the server, and one or more computing devices;
a memory configured to store instructions; and
one or more processors coupled to the communication interface and the memory and configured to execute a management application for the server, wherein the one or more processors are configured to:
collect request data for requests submitted to the server at the datacenter;
determine a request metric and a window based on the collected request data, wherein the request metric defines a limit for a number of requests from a source to be accepted within the window;
monitor incoming requests for the server at the datacenter;
identify a subset of requests from the source;
count the subset of the requests associated with the identified source; and
in response to determining that a number of requests from the source exceed the determined request metric within the window, deny further requests from the source until the window expires.

13. The server of claim 12, wherein the one or more processors are further configured to:
for every incoming request, create or update a record at a local cache of the server and a common cache of the datacenter, the record comprising a counter for the request, a source identifier, and a window identifier.

14. The server of claim 13, wherein the record is stored at the common cache as a combination key of the counter for the request, the source identifier, and the window identifier.

15. The server of claim 13, wherein the one or more processors are further configured to:
for every incoming request, query the common cache for a maximum value hit of the record to determine if the further requests are to be denied.

16. The server of claim 13, wherein the common cache is associated with at least a subset of servers at the datacenter such that all requests submitted to the servers at the datacenter are monitored at the common cache.

17. A datacenter to provide accelerated throttling for web servers and services, the datacenter comprising:
a common cache shared among a plurality of servers of the datacenter; and
the plurality of servers configured to execute one or more hosted services or applications, each of the plurality of servers comprising:
a communication interface configured to facilitate communication between the plurality of servers, and one or more computing devices submitting requests to the plurality of servers;
a memory configured to store instructions; and
one or more processors coupled to the communication interface and the memory and configured to execute a management application for a respective server, wherein the one or more processors are configured to:
determine a request metric and a window based on historic usage information, wherein the request metric defines a limit for a number of requests from a source to be accepted within the window;
monitor incoming requests by creating or updating a record at a local cache of the respective server and at a common cache of the plurality of servers for every incoming request, the record comprising a counter for the request, a source identifier, and a window identifier,
query the common cache for a maximum value hit of the record; and
in response to determining the maximum value hit, deny further requests from the source until the window expires.

18. The datacenter of claim 17, wherein the metric is determined based on a sum of an average number of requests from the source over a predefined period and a buffer number of requests.

19. The datacenter of claim 17, wherein the metric is weighted based on one or more of a timing of the requests, a type of the requests, a type of different sources, and a type of servers receiving the requests.

20. The datacenter of claim 17, wherein the one or more processors are further configured to:
collect request data for requests submitted to the respective server while monitoring the incoming requests; and
dynamically update one or more of the metric and the window.
